(19) United States
(12) Patent Application Publication
(10) Pub. No.: US 2003/0083986 A1
(43) Pub. Date: May 1, 2003

(54) Method of credit guarantee in electronic commerce

(76) Inventor: Toshiaki Kobayashi, Nagano-ken (JP)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/014,946

(22) Filed: Oct. 26, 2001

(51) Int. Cl. G06F 17/60

(52) U.S. Cl. 705/39

(57) ABSTRACT

This invention is directed to a highly reliable method of credit guarantee in electronic commerce transactions through an interconnected network. The method involves substitute-billing by the settlement agency for transaction payment accrued in the electronic commerce transaction between the member computer 10 registered in the settlement agency and the shop server 20b operated by the product selling entity, the transaction approval server 20c that maintains the identity information of many settlement agencies and many product selling agencies is in data communication with the member maintenance server 20a and the shop server 20b, and provides the identity information of the other party to both servers 20a and 20b in a timely manner, and maintains the transaction evidence by maintaining the order number, which was issued for each transaction, and the contents of such transaction.

### BACKGROUND OF THE INVENTION

The present invention relates to a method of credit guarantee in electronic commerce transactions. More particularly, the present invention is directed to a method of credit guarantee in electronic commerce transactions through an interconnection network, such as the Internet, comprised of a plurality of individual networks and/or computer systems, wherein such individual networks and/or computer systems may be part of networks with different stipulations.

In recent years, business transactions, such as electronic commerce, via a communication network have increased significantly. One explanation for this is the widespread use of the Internet. The procedure for an electronic commerce transaction shall be explained by way of example of an electronic commerce transaction between a purchaser of a product, wherein the purchaser is using a computer (user computer) to access the Internet, and an electronic retail entity or shop operated by a seller of product (shop).

An electronic shop is characterized by a group of Web pages (a Web site) opened by a retail entity or shop on the Internet. Such an electronic shop is typically stored within a database connected to a world wide web (WWW) server, wherein the database contains HTML text and is composed of forms with entry spaces for required items in receiving a purchase order or a list of products sold, or image data inserted in such text.

A purchaser accesses to the Internet by a proper connection method, such as a dial-up connection through his or her user computer. The purchaser then browses through the web pages of an electronic shop using a browser, and confirms the price, specifications and other items for a desired product. Once the decision is made to purchase an item, the purchaser accesses the web page for the purchase order form for the shop.

The purchase order form typically includes various entries to be filled in so as to specify the delivery point, such as name and address, and an accounting method (transfer via a bank, pay on delivery, pay by credit card, etc.). After filling in the necessary entries of the form, the purchaser sends the form to the appropriate location. Concurrently, the WWW server for the electronic shop is notified of the product purchase event and information relating to the ordered product, purchaser, purchase date, payment details as well as the delivery address of the event (the storage place and the location of the program to be given as a parameter), etc.

A manager of the electronic shop then obtains data equivalent to the product purchase event via a computer, etc. operated by himself or herself in real time or at a later time, and carries out a delivery processing of the specified product to the specified address according to this event and an accounting processing according to the specified method.

Electronic commerce through the Internet is significantly different from the electronic commerce used in such previous computer communication network with a closed network (individual network) in that the product purchaser (user) and the seller of the product (shop) may be affiliated with networks operated under different stipulations.

When a purchaser and a shop make an electronic commerce transaction under the same stipulation and are registered in the same network, then the operator of such network makes an assurance of identity of each. When there is a problem, the identity of a party can be quickly verified to the other party, and the record and the security of transaction evidence is easily maintained.

However, in cases of an electronic commerce transaction through an interconnection network comprised of many individual networks having different stipulations, such as the Internet, it is very difficult for the purchaser and the seller to make the judgment as to where to put the foundation of trust in the other party. For example, sellers seek the disclosure of private information of a purchaser, and try to insure the collection of payment and the ready identification of a purchaser should there be a problem.

For purchasers, the foundation of trust in a shop is more uncertain. There is a possibility that a shop will “disappear” after collecting the payment for the products. At that point, it will be extremely difficult for the purchaser to identify the shop. Moreover, even when purchasing a product such as a software or data by downloading, the purchaser is generally required to disclose more of his or her private information than is necessary. Therefore, a purchaser is constantly exposed to the danger of misuse or disclosure of his or her private information.

There exists an authentication system for mutual identity assurance by a third party on the Internet. However, since the registration and deletion of identity information to a verification server operated by such system is easily done, it is possible to erase the identity information right after the completion of the commercial transaction. Of course, then there is no ability to guarantee the transaction itself. If the evidence of transaction is to be guaranteed, then the parties must disclose extremely detailed private information to each other.

Therefore, there is a need to provide a highly reliable credit guarantee method without the disclosure of private information for electronic commerce through an interconnection network, such as the Internet, and the various computer systems associated with such method.

### SUMMARY OF THE INVENTION

In accordance with the present invention, there is provided a highly reliable credit guarantee method without the disclosure of private information for electronic commerce through an interconnection network, such as the Internet, and the various computer systems associated with such method.

The method for credit guarantee according to the present invention is used in an electronic commerce transaction via an interconnected network comprised of several individual networks, wherein the transaction occurs between a shop server operated by a product selling entity and a member computer used by a member who is contracted with the settlement agency. The method is comprised of the following steps and components.

(1) A settlement agency operates a member management server that is connected to an interconnection network. The member maintenance server manages the information of members for a plurality of members. When a member computer logs-in after going through a designated verification procedure, the log in periods and the anonymous user ID for the member's computer is maintained by corresponding the information to the member list information.

(2) A transaction approval server operated by a credit guarantee institution is connected to the interconnection network. The transaction approval server maintains an aggregated database of shop information comprised of payment methods and private information for each of the many product selling entities and collection institution information comprised of payment methods and private information for each of the many settlement agencies. The transaction approval server communicates with the member maintenance server or shop server accessed by the transaction approval server, after passing through a designated verification procedure.

(3) A shop server receives anonymous user ID for each member computer that directly or indirectly accesses the shop server, and it reacts to the product purchase event that this member computer had sent by forwarding to the transaction approval server a settlement agency identification search request message with anonymous user ID.

(4) The transaction approval server sends back to the shop server a settlement agency identification guarantee message generated after searching the database for the anonymous user ID contained in the settlement agency identification search request message and selecting the appropriate information from related settlement agency information.

(5) The shop server access the member maintenance server based on the address information contained in the settlement agency identification guarantee message, and sends the billing substitute request message contained within shop identification information relating to the its own identification and the anonymous user ID.

(6) The member maintenance server sends the transaction approval server a shop identification search request message containing the shop identification information contained in the billing agency identification search request message.

(7) The transaction approval server searches the database based on shop identification information included in the shop identification search request message, then, selects the appropriate information from related shop information, and returns a shop identification guarantee message to the member maintenance server.

(8) The member maintenance server, once it receives the shop identification guarantee message, based on the time of occurrence (transaction time) of product purchase event and anonymous user ID included in the billing substitute request message sent by the shop server, confirms the completion of transaction by sending a transaction confirmation notice that includes the one and only order number generated by the shop server or member maintenance server and selected information from the applicable member list information, shop identification guarantee message, or billing substitute request message, to the applicable member computer that is already logged in.

(9) The member maintenance server, after it confirms the transaction completion, records the order number and the appropriate information selected from billing substitute request message by associating them to the applicable member information, and sends information selected from billing substitute request message and transaction completion report message including order number and the result of transaction completion notice to the shop server, and sends a transaction report message that includes the order number and information selected from billing substitute request message to the transaction confirmation server.

(10) The shop server, once it receives the transaction completion report message, sends a transaction verification request message that includes the order number to the transaction approval server.

(11) The transaction approval server records the applicable order number and applicable transaction monies in the transaction record book by corresponding the order number with information contained in the transaction report message and transaction verification request message, and sends a transaction verification message that corresponds the order number to the shop server.

(12) The shop server, once it receives the transaction verification message, records the order number in this verification message and the information selected from the settlement agency identification guarantee message or billing substitute request message that were the acceptance origin of the transaction verification message to the sales record book.

In a second embodiment of the present invention, items (3) through (5) above are replaced with the following items.

(3) The transaction approval server timely sends a settlement agency identification guarantee message generated from selective information from settlement agency information concerning the settlement agency to the shop server.

(4) The shop server acquires the anonymous user ID assigned to the member computer that directly and indirectly access the shop server, and the address information for the member maintenance server that is assigned to this ID is selected from the settlement agency identification guarantee message sent by the transaction verification server

(5) The shop server reacts to the product purchase event sent by the member computer, and compiles selected address information relating to the member maintenance specified by the anonymous user ID. The shop server sends a billing substitute request message that includes the shop identification information relating to the its own identification and the anonymous user ID.

In another embodiment of the present invention, items (3) and (4) from the second embodiment are replaced with the following items.

(3) The shop server maintains and manages suitable information from the related member maintenance server as the settlement agency identification guarantee information.

(4) The shop server acquires the anonymous user ID assigned to the member computer that directly and indirectly accessed the shop server, and the address information for the member maintenance server that re assigned to this ID is selected from settlement agency identification guarantee message.

Further, in accordance with the present invention, there is provided a method for guarantee in electronic commerce transactions between at least one member and at least one retail entity, the method comprising:

accessing a member maintenance server operated by a settlement agency by a member desiring an electronic commerce transaction with a retail entity, wherein the member maintenance server verifies the member's identification and any associated member information of the member;

generating selected information relating to at least one of selected payment method information and associated private information about the retail entity from selected information obtained from a transaction approval server operated by a credit guarantee institution and transmitting the selected information to at least one of the member maintenance server and retail entity server which requested the information;

generating an anonymous user identification from selected information obtained from at least one of the member which accessed the retail server and the member maintenance server and transmitting the anonymous user identification from the member maintenance server to the retail entity server;

generating a settlement agency identification search request message from selected information obtained from the retail entity server and transmitting the settlement agency identification search request message from the retail entity server to the transaction approval server, wherein the settlement agency identification search request message includes the anonymous user identification for the member;

searching settlement agency information for information related to the anonymous user identification obtained from the retail entity server and transmitting selected information related to the anonymous user identification from the transaction approval server to the retail entity server;

generating a billing agency identification search request message from selected information obtained from the retail entity server and transmitting the billing agency identification search request message from the retail entity server to the member maintenance server, wherein the billing agency identification search request message includes retail entity identification information and the anonymous user identification;

generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;

generating a retail entity identification guarantee message from selected information obtained from the transaction approval server and transmitting the retail entity identification guarantee message containing the selected information from the transaction approval server to the member maintenance server;

verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;

storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;

generating a transaction report message from selected information obtained from the member maintenance server and transmitting the transaction report message to the transaction confirmation server, wherein the transaction report message includes the order number and selected information from the billing agency identification search request message;

upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;

verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and

upon receipt of the transaction verification message by the retail entity server, storing the order number and selected information from at least one of the settlement agency identification guarantee message and the billing agency identification request message in a sales record database within the retail entity server.

Still further, in accordance with the present invention, there is provided a method for guaranteeing credit in electronic commerce transactions between at least one member and at least one retail entity, the method comprising:

accessing a member maintenance server operated by a settlement agency by a member desiring an electronic commerce transaction with a retail entity, wherein the member maintenance server verifies the member's identification and any associated member information of the member;

generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;

generating a settlement agency identification guarantee message from selected information obtained from the transaction approval server and transmitting the settlement agency identification guarantee message from the transaction approval server to the retail entity server;

generating an anonymous user identification from selected information obtained from the member which accessed the retail server and transmitting the anonymous user identification from the member to the retail entity server;

compiling selected address information relating to the member maintenance server assigned to the anonymous user identification from selected information contained in the settlement agency identification guarantee message received by the retail entity server;

generating a billing agency identification search request message from selected information obtained from the retail entity server and transmitting the billing agency identification search request message from the retail entity server to the member maintenance server, wherein the billing agency identification search request message includes retail entity identification information and the anonymous user identification;

generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;

generating a retail entity identification guarantee message from selected information obtained from the transaction approval server and transmitting the retail entity identification guarantee message containing the selected information from the transaction approval server to the member maintenance server;

verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;

storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;

generating a transaction report message from selected information obtained from the member maintenance server and transmitting the transaction report message to the transaction confirmation server, wherein the transaction report message includes the order number and selected information from the billing agency identification search request message;

upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;

verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and

upon receipt of the transaction verification message by the retail entity server, storing the order number and selected information from at least one of the settlement agency identification guarantee message and the billing agency identification request message in a sales record database within the retail entity server.

Still further, in accordance with the present invention, there is provided a method for guaranteeing credit in electronic commerce transactions between at least one member and at least one retail entity, the method comprising:

accessing a member maintenance server operated by a settlement agency by a member desiring an electronic commerce transaction with a retail entity, wherein the member maintenance server verifies the member's identification and any associated member information of the member;

generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;

periodically accessing and obtaining selected information from the member maintenance server and maintain such information in a settlement agency identification guarantee information database on the retail entity server;

generating an anonymous user identification from selected information obtained from the member which accessed the retail server and transmitting the anonymous user identification from the member to the retail entity server;

compiling selected address information relating to the member maintenance server assigned to the anonymous user identification from selected information contained in the settlement agency identification guarantee information database on the retail entity server;

generating a billing agency identification search request message from selected information obtained from the retail entity server and transmitting the billing agency identification search request message from the retail entity server to the member maintenance server, wherein the billing agency identification search request message includes retail entity identification information and the anonymous user identification;

generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;

generating a retail entity identification guarantee message from selected information obtained from the transaction approval server and transmitting the retail entity identification guarantee message containing the selected information from the transaction approval server to the member maintenance server;

verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;

storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;

generating a transaction report message from selected information obtained from the member maintenance server and transmitting the transaction report message to the transaction confirmation server, wherein the transaction report message includes the order number and selected information from the billing agency identification search request message;

upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;

verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and

upon receipt of the transaction verification message by the retail entity server, storing the order number and selected information from at least one of the settlement agency identification guarantee message and the billing agency identification request message in a sales record database within the retail entity server.

These and other aspects of the invention will be apparent to one of ordinary skill in the art upon the reading and understanding of the specification.

### BRIEF DESCRIPTION OF THE DRAWINGS

FIG. 1 is a schematic block diagram of the network on the Internet.

FIG. 2 is a schematic block diagram of the network in a first example of present invention.

FIG. 3A shows a procedure diagram of a communication procedure carried out between the member maintenance server that forms the network mentioned in the first example and the transaction approval server when the settlement agency program is installed.

FIG. 3B shows a procedure diagram of a communication procedure carried out between the shop server that forms the network mentioned in the first example and the transaction approval server when the shop program is installed.

FIG. 3C is a schematic diagram of the contents of information transmitted in the above procedure.

FIG. 4 is a procedure diagram of the member computer that forms the network mentioned in the first example when it logs into the member maintenance server.

FIG. 5 is a procedure diagram of a communication procedure in the electronic commerce transaction in the first example.

FIG. 6 is a schematic diagram of the contents of information transmitted when the electronic commerce transaction is communicated.

FIGS. 7A and 7B show an example of a cancellation procedure from the first example. FIG. 7A shows a procedure diagram of such procedure and FIG. 7B shows a schematic diagram of the contents of information transmitted in such procedure.

FIGS. 8A and 8B show a second example of a cancellation procedure in the first example. FIG. 8A shows a procedure diagram of such procedure and FIG. 8B shows a schematic diagram of the contents of information transmitted in such procedure.

FIGS. 9A and 9B show an example of the procedure when the settlement agency deposits transaction fee collected from the member to the shop in the first example. FIG. 9A shows a procedure diagram of such procedure and FIG. 9B shows a schematic diagram of information transmitted in such procedure

FIGS. 10A, 10B, and 10C show an updating procedure of identification information registered in the transaction approval server in the first example. FIG. 10A shows a communication procedure between the member maintenance server and the transaction approval server, FIG. 10B shows a communication procedure between the shop server and the transaction approval server, and FIG. 10C is a schematic diagram of the contents of the information transmitted in the procedures in FIGS. 10A and 10B.

FIG. 11 is a schematic diagram of an example of connection condition between the member computer and the member maintenance server in the second example in present invention.

FIG. 12 is a schematic diagram of network in the third example of present invention.

### DESCRIPTION OF THE PREFERRED EMBODIMENTS

Interconnection Network

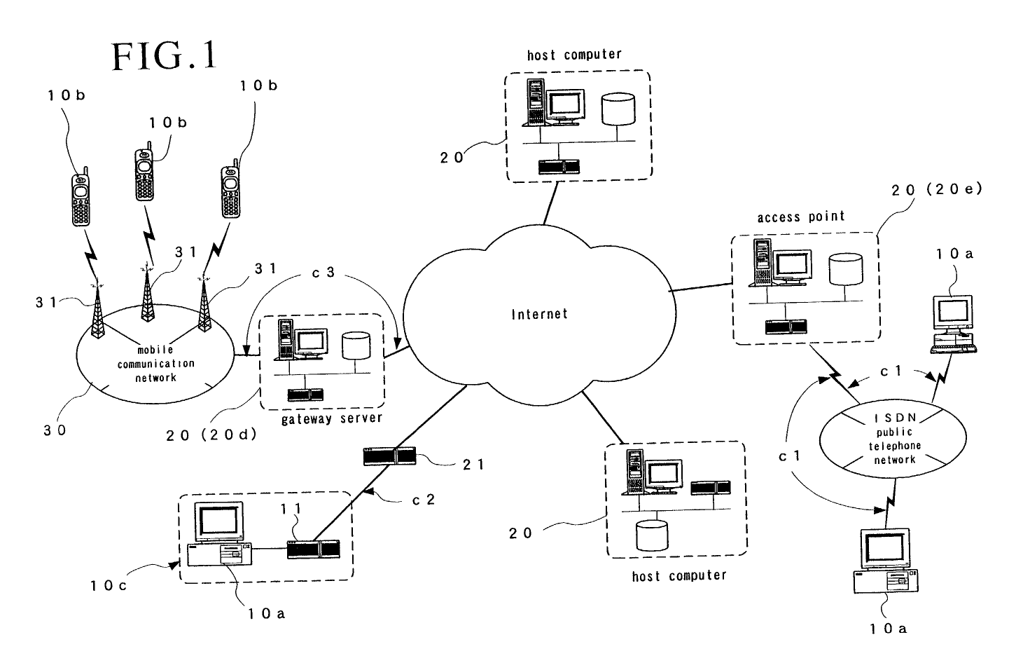

The Internet is used as an example of an interconnection network in which the present invention for a method of credit guarantee is applied. FIG. 1 is a schematic block diagram of the Internet. The Internet is a “network between network” where each network, like a network operated by a provider or LAN, is connected to each other. There are enormous numbers of various computers, from user computers, 10a through 10c, operated by an average user, to host computer 20 like WWW server, that are connected organically in this interconnection network.

There are many types of user computers and many methods to connect to the Internet. If a user computer is an average personal computer 10a, then it is customary to use a dial-up IP connection (c1) via an access point 20e provided by an Internet connection entity (provider). If it is a private line, then a personal computer 10a connected to router 11 forms a user computer 10c, and such router 11 is connected to the router 21 managed by the provider.

If the connection to the Internet is independently capable, such as a portable phone 10b, then such portable phone 1ob connects to the mobile communication network via wireless base station 31. Also, a mobile communication entity's protocol converter called gateway server 20d interconnects (c3) the mobile communication network 30 and the Internet.

The present invention is directed to a method of credit guarantee in electronic commerce transactions through an interconnection network such as the Internet. The computer systems which are used in the present invention are defined as below.

Member Maintenance Server

The member maintenance server is defined as a host computer that maintains member information relating to the many registered members, and also maintains the database of private information (member information) of each member on the network. The member maintenance server is operated by a settlement agency which also collects the purchase payment on behalf of a shop when a member purchases a product from a shop through an electronic commerce transaction.

Member Computer

The member is defined as a registered member in contract with a suitable settlement agency and who purchases a product from a shop on the network. The member computer is defined as a user computer used by a member for electronic commerce on the network.

Shop Server

A product selling agency (shop) is defined as an agency operating an electronic shop that sells product on the network, and the shop server is defined as a host computer that displays electronic shops on a web site.

Transaction Approval Server

The credit guarantee agency is defined as an agency that enters into contracts with many product selling agencies and many settlement agencies, and makes credit guarantees relating to the commercial transaction between a product selling agency and a member of a credit guarantee agency. The transaction approval server is defined as a host computer that maintains the database of information for each agency with which the credit guarantee agency enters into a contract and the transaction approval server operates on the network.

Summary of the Method of Credit Guarantee

An example of the present invention is a business model wherein a member registered with a provider makes an electronic commerce transaction and such provider makes a substitute collection of purchase price. In this model, the provider maintains the IP address of the member, and the member pays an established Internet connection fee to the provider.

The shop server receives the IP address of the member computer that accessed the shop server as a product purchaser, and uses this as distinct information (anonymous user ID) to specify an individual without disclosing the private information. The shop server sends the IP address received to the corresponding computer in the member maintenance server operated by the provider, and the shop server requests payment for the purchase to such computer. The provider then determines which member used such IP address on a date the electronic commerce transaction occurred, and in the future, collects the purchase price for product purchased in the electronic commerce transaction and the Internet connection fee from the member.

However, as mentioned above, there are many ways to connect to the Internet by the user computer. For example, one computer is used by many people or an IP address is shared by multiple computers. Therefore, the possibility exists that the IP address may not be the anonymous user ID. Moreover, there are many Internet users that do not subscribe to a specific provider as one can access the Internet by using an information fee collection substitute service by a communication business entity, or one can take advantage of free Internet connection services operated by advertising earnings. Of course, there are interconnection networks other than the Internet where several LANs are interconnected through gateway.

Therefore, the present invention offers a general-purpose business model in which provides credit guarantee without the disclosure of private information in electronic commerce through an interconnection network.

The basic idea is that the credit guarantee agency enters into individual contract with many settlement agencies and many shops, and when the electronic commerce transaction between a shop and a registered member in each settlement agency is made, it guarantees the personal guarantee of both the shop and the settlement agency and preserves the evidence relating to the collection substitute. The settlement agency preserves the evidence of electronic commerce transaction and the personal guarantee of a member by maintaining information about the member that made commercial transaction.

Network Structure

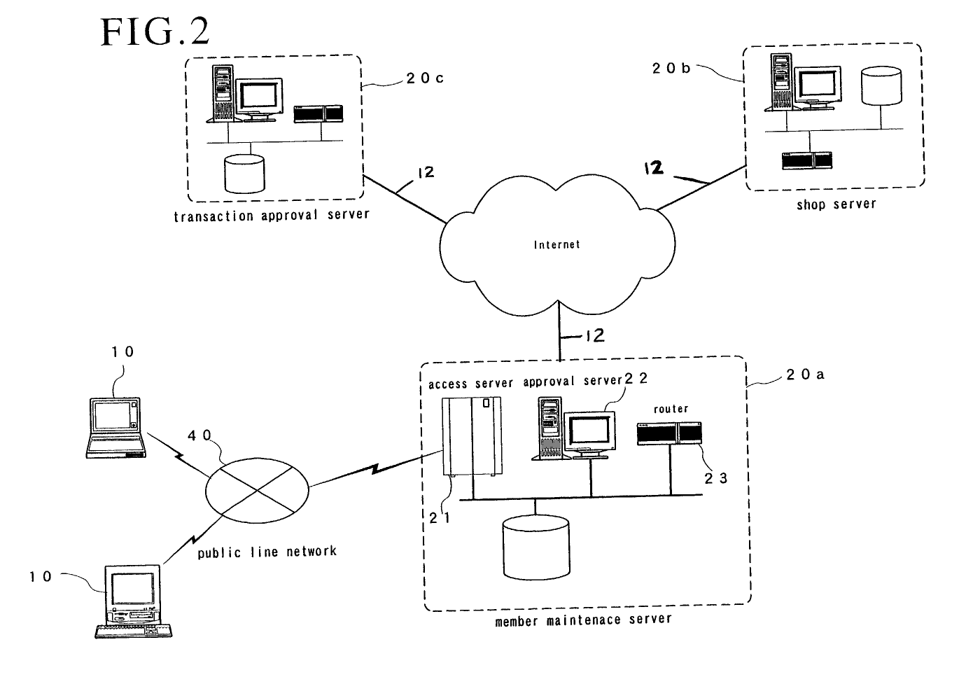

As mentioned above, in one embodiment, the provider functions as a settlement agent, and the member computer connects to the Internet by a dial-up IP connection. Below is an explanation of the network structure and the communication procedure as Example 1 when the present invention is applied to such a model. FIG. 2 is the schematic diagram of the network structure in this Example 1.

In Example 1 as shown in FIG. 2, the member computer 10 access to the Internet by a dial-up IP connection 40, and the member computer 10 and the shop server 20b participate in an electronic commerce transaction Based on this commercial transaction, the member server 20a, the shop server 20b, and the transaction approval server 20c have reciprocal communication transmissions between each other through the Internet which are shown as 12. In this example, the member maintenance server 20a and the shop server 20b make the communications through the Internet, but, of course, the private line can also be used.

The member maintenance server 20a includes the access server 21 that connects the member computer 10 to the Internet by rending an suitable IP address when accesses the member maintenance server by the PPP procedure. The member maintenance server also includes the approval server 22 which maintains the passwords and ID for each member and performs the approval procedure based on the passwords or ID received by the access server 21 from user computer 10 and also records, in an access log, which ID is allocated to which IP address for which time period. The member maintenance server further includes a router 23.

Moreover, the member maintenance server 20a or the shop server 20b suitably may function as a WWW server and react to the HTTP request from the accessed member computer 10, return to the specific web page request, and start-up the fixed program, such as CGI, by returning the process result as a web page form.

Installation of Program

The shop server or the member maintenance server is the computer system operating due to the action of the host computer or the computer installed with a program, or the computer system installed with program to process the collection substitute or electronic commerce transaction according to the present invention to the host computer

In this example, the above program is installed in the WWW server as the CGI. The program installed in the shop server is defined as a shop program, and the program for the member maintenance server is defined as the settlement agency program.

If such program can be obtained or installed without any regulation, then substitute collection can be wrongly obtained in a forged electronic commerce transaction by fabricating the shop server or by stealing the product without substitute collection by fabricating the member maintenance server. If the program is sold only to the shop or the settlement agency that entered into a formal contract with the credit guarantee agency, then the identification of the program purchaser becomes clear and the possibility in misuse of program will be extremely lowered. However, that will not be the case if the program itself is copied.

Procedure of License Key Issuance

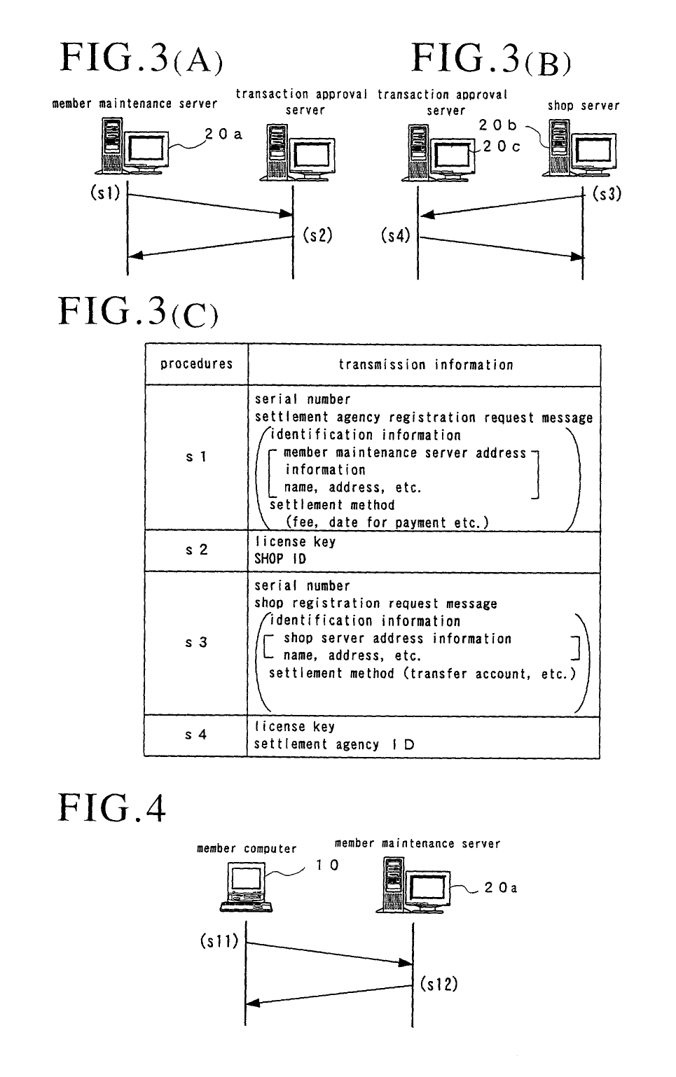

FIG. 3A and 3B show the communication procedure between the transaction approval server 20c and the member maintenance server 20a when it installs the settlement agency program, and the communication procedure between the transaction approval server 20c and the shop server 20b when it installs the shop program, respectively. Also, FIG. 3 (C) is the contents of information exchanged in the above procedures.

When the settlement agency or the shop tries to install the lawfully purchased program to the each entity's computers, these computers connect to the transaction approval server 20c, and transmit the shop registration request message and the settlement agency registration request message that includes information concerning the settlement method or the identification and the particular serial number of the shop or the settlement agency for such program (s1,s3). The transaction approval server 20c in exchange for sending of the registration request messages, and issues and sends the license key (s2,s4) to the member maintenance server or the shop server. The license key is the identification information needed for access to the transaction approval server 20c by the member maintenance server 20a and the shop server 20b. The transaction approval server 20c registers the license key and the corresponding serial number in order to avoid the multiple installation of same program to the varied computers.

Also, the transaction approval server 20c issues the settlement agency ID to the member maintenance server 20a and the shop ID to the shop server 20b, along with the license key. The settlement agency ID and the shop ID contain information concerning the identification of the agency and the shop, respectively, which is when the member maintenance server 20a and the shop server 20b communicate with the transaction approval server.

The name of the settlement agency, address, representative, address of the member maintenance server, corresponding anonymous user ID, and the settlement method (fee, transfer date etc.) are registered on a database on the transaction approval server as settlement agency information. The shop name, address, representative, shop server address, and the settlement method (transfer account etc.) are registered on a database on the transaction approval server as the shop information.

The anonymous user ID in the settlement agency information is the information disclosed to the shop server 10b in an electronic commerce transaction by the member computer 10a. In the present example, it is the IP address used by the member computer 10 when connecting to the Internet. Assignment of the anonymous user ID becomes the address range (Net mask) of the IP address the provider assigned to the member computer 10a.

Also, in this example, the address information included in the identification information of the member maintenance server 20a or the shop server 20b is registered after the transaction approval server 20c receives the sender IP address of the member computer.

Log-In to the Member Maintenance Server

The member computer 10 needs to log-in to the member maintenance server when it commences the electronic commerce transaction in the present invention. FIG. 4 is the summary of such log-in procedure. The member computer 10 accesses to the member maintenance server 20a and sends member ID and passwords to the member maintenance server. In this example, the log-in procedure is the approval procedure used to approve the passwords and the member ID received when the member computer 10a accesses the member maintenance server 20a through the known PPP procedure.

The member maintenance server then searches the database for these passwords and member ID and retrieves the applicable member information. The member maintenance server then assigns an anonymous user ID to this member computer 10. In this example, the IP address is issued as anonymous user ID (s12). The member maintenance server 20 assigns the IP address only when the member computer 10a is connected to the dial-up IP connection. The member maintenance server 10a records the IP address and the periods of time for log-in and stores them with the applicable member information.

The anonymous user ID is important aspect of present invention. The member maintenance server 20a assign the anonymous user ID to the specific member. The member computer 10 discloses this anonymous user ID, in substitute for the private information of the member, to the shop server 20b when making an electronic commerce transaction with the shop server 20b. The settlement agency, on behalf of the shop, collects the transaction charge against the user of this anonymous user ID.

Credit Guarantee and the Electronic Commerce Transaction

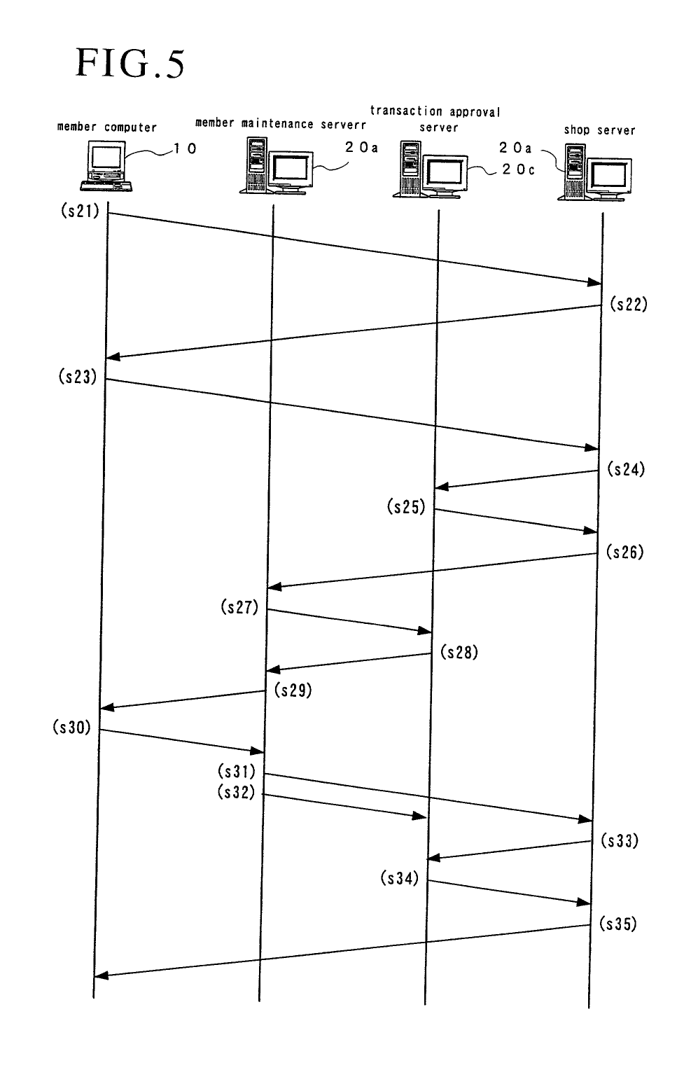

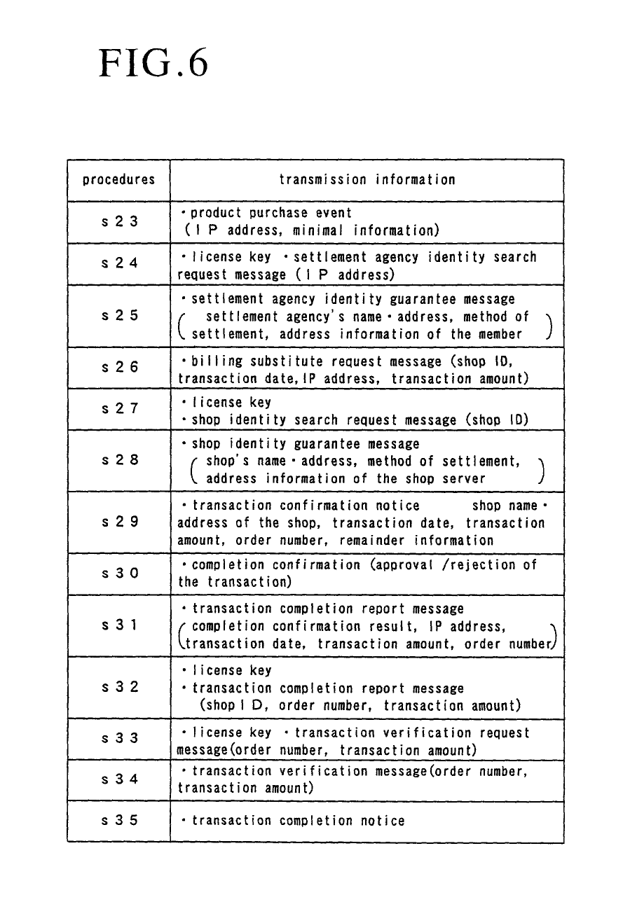

FIG. 5 and FIG. 6 show the electronic commerce transaction along with the procedure for the credit guarantee and the contents of information transmitted in this procedure.

Accrual of Product Purchase Event

The member computer 10, through an HTTP request/response to the shop server 20b, sends for a web page to receive order instructions for a product purchase or the web page for product description (s21,s22). In this page, there are spaces to fill in related to the delivery point and other information for each product ordered. If the product is data, software or others that are sold by downloading, then the above information is not generally needed.

The shop server 20b receives the IP address of member computer 10 when the instruction for the order of the product (accrual of product purchase event, s23) is made by way of returning the filled in form, and records the time of product purchase event (transaction date), transaction amount including shipping charge, tax, and product charge, and the name of ordered product and stores such information in connection with this IP address.

Identity Search Request of Settlement Agency

The shop server 20b, by reacting to the product purchase event (s23), accesses the transaction approval server 20c and starts the approval procedures using its license key. Afterwards, the settlement agency identity search request message that includes IP address disclosed by the member computer 10 is returned to the transaction approval server 20c (s24).

The transaction approval server 20c selects the applicable settlement agency by searching the database for the IP address, generates the settlement agency identity guarantee message, which includes selected settlement agency information concerning this agency, sends the settlement agency identity guarantee message to the shop server 20b (s25). In this example, the settlement agency identity guarantee message includes the settlement agency's name, address, method of settlement and the address of the member maintenance server that this settlement agency manages which are selected from the applicable settlement agency information.

Billing Substitute Request

The shop server 20b accesses the member maintenance server 20a based on the address information included in the settlement agency identity guarantee message, and sends the billing substitute message that includes shop ID for its own identity information and the IP address received from the member computer 10 (s26). In this example, the billing substitute request message includes transaction amount and date, the shop ID and the IP address.

Identity Search Request of Shop

The member maintenance server 20a receives the address information of the shop server 20b that sent the billing substitute request message. Afterwards, it accesses the transaction approval server 20c and starts the approval procedures using its license key, and sends shop identity search request message that includes shop ID and other information contained in the billing substitute request message (s27).

The transaction approval server 20c searches the database based on the shop ID included in the shop identity search request message, and selects the shop's name, address, transfer account, and other information in the applicable shop information, and returns such selected information as the shop identity guarantee message to the member maintenance sever 20a (s28). Also, in this example, the address information of the shop server 20b is also included in this message. As result, the member maintenance server 20a verifies the address information received in the billing substitute request message with the address information received from the transaction approval server 20c, and is able to determine if this billing substitute request is sent from the rightful shop server 20b.

Transaction Confirmation Notice

The member maintenance server 20a, once it receives the shop identity guarantee message, generates the one and only order number to uniquely specify the applicable electronic commerce transaction, and sends the transaction confirmation notice that includes such order number and selected information from the billing substitute request message to the member computer 10 that currently uses IP address recorded in the billing substitute request message previously received (s29).

The transaction confirmation notice is sent to the member computer 10 as a web page, and the order number, name and address of the shop, transaction date, and the transaction amount of the applicable transaction is contained in this page. Moreover, based on the applicable member information, the transaction amount or the order number of other electronic commerce transactions that did not complete the billing substitute is stated in the transaction confirmation notice as remainder information. As result, commercial transactions by the “forged member” that unjustly obtained the member ID and the passwords are detected right away.

Also, the member computer 10a in this example has the built-in program that displays the web page sent unilaterally by the member maintenance server 20a, without using HTTP, as function enhancement software (plug-in) for the browser.

Completion Confirmation, Transaction Completion Confirmation Report, Transaction Report

Once the transaction confirmation notice is received, the user input for instructing the approval or rejection is made by the member to the member computer 10, and such input information is sent to the member maintenance server 20a as the completion confirmation (s30). The member maintenance server 20a stores the completion confirmation result (approval or rejection of the transaction), the applicable billing substitute request message, and the order number with the applicable member information. Afterwards, the completion confirmation result, selected information (IP address, transaction date, transaction amount) from the billing substitute request message, and the transaction completion report message, and the order number are sent to the shop server 20b (s31). Moreover, selected information (shop ID, transaction amount) from the billing substitute request message and the transaction report message, and the order number are sent to the transaction approval server 20c (s32).

Transaction Verification

The shop server 20b sends the order number stated in the transaction completion report received from the member maintenance server 20a and the transaction verification request message that includes transaction amount to the transaction approval server 20c (s33). Also, before transaction verification request message is sent to the transaction approval server, the shop server 20b, in this example, verifies the address information of member maintenance server that requested the billing substitute with the address information of the member maintenance server that sent the transaction completion report message. As result, whether this transaction completion report message is received from the rightful member maintenance server is identified.

The transaction approval server 20c compares the order number and the transaction amount that are included in both in the transaction report message received from the member maintenance server 20a and the transaction verification request message received from the shop server 20b. If they coincide, such order number and the applicable transaction amount is recorded in the transaction record book associating the settlement agency with the shop concerned, and maintained as the transaction evidence. Afterwards, the transaction approval server sends the transaction verification message to the shop server 20b indicating that the order number and the transaction amount have coincided (s34). Also, the transaction approval server 20c, in this example, creates, as the database for verification of existence of electronic commerce truncation specific to the order number, the transaction certificate that is difficult to forge based on the suitable encryption algorithm, and attach this certificate to the transaction verification message.

Transaction Completion Notice

The shop server 20b, once it receives the transaction verification message, records in the sales records book selected information from the contents of the transaction (identity information and settlement method of the settlement agency of which the billing substitute was requested, transaction date, and the transaction amount) or the transaction certificate with the applicable order number. Afterwards, the transaction completion notice in forms of Web page indicating the transaction is completed to the member computer 10 (s35).

Other Procedures

The computer systems used in the present invention often need to perform various procedures by timely communication in addition to those described above. Such various procedures and the method of credit guarantee in such procedures are explained below.

Cancellation: First Embodiment

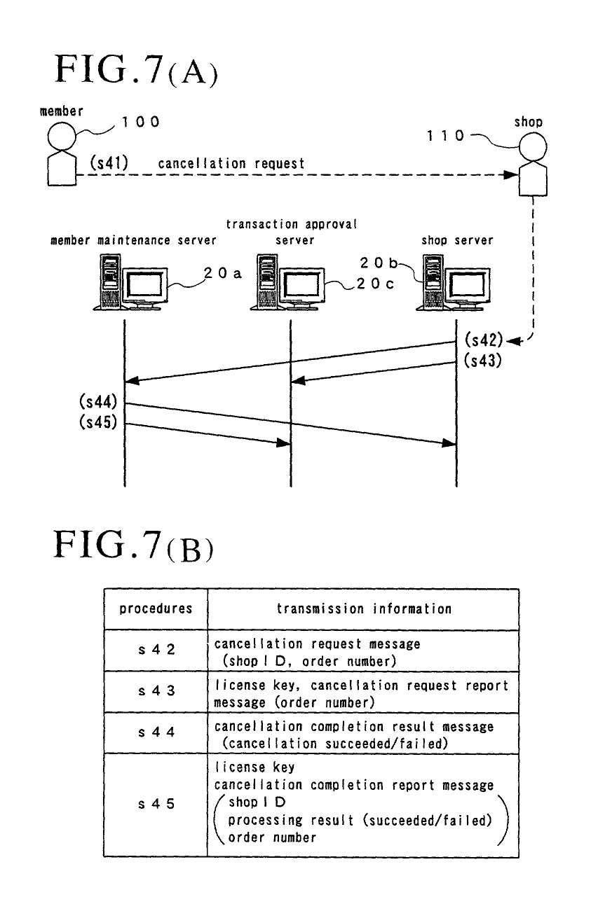

There are instances where the purchased product is returned after transaction is completed or the member cancels due to the delay in delivery or other reasons. FIGS. 7A and 7B show the examples of such cancellation procedures. FIG. 7A shows the communication procedure and FIG. 7B shows the communication contents. A cancellation request (s41) is sent by the member 100 for a transaction with the specific order number to the shop 110. The shop server 20b determines the settlement agency which was the substitute for the billing concerning the applicable transaction using the sales record book. The shop server accesses the member maintenance server 20a for such settlement agency and sends the cancellation request message to stop the substitute billing for the transaction specific to the order number (s42). Also, the cancellation request report message that indicates the cancellation is sent to the transaction approval server 20c (s43).

The member maintenance server 20a searches the member information corresponding to the order number in the cancellation request message, and determines whether the applicable transaction may be canceled based on whether the substitute billing was already taken place, and stores the results of such determination with the applicable member information. The member maintenance server sends the result of such determination to the shop server as a cancellation completion result message (s44).

Also, the member maintenance server 20a sends to the transaction approval server 20c selected information from the notice of cancellation request concerning the transaction and the result of determination as a cancellation completion report message (s45). This report (s45) includes the result of such determination, the shop ID and the order number of the shop server that requested the cancellation. The transaction approval server 20c records the result of determination in the applicable transaction record book once it receives the cancellation completion report message.

Cancellation: Second Embodiment

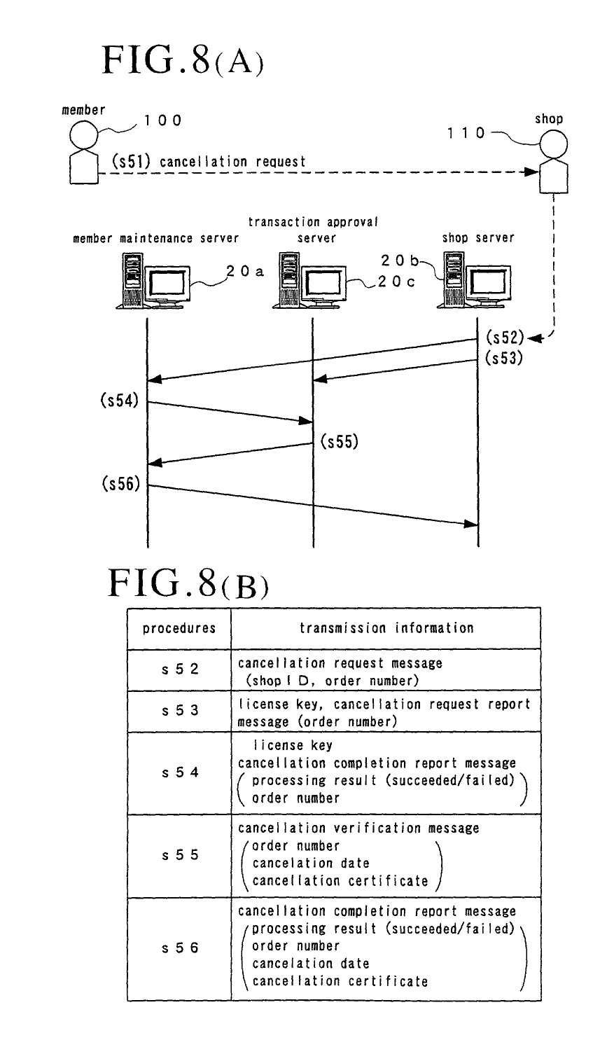

FIGS. 8A and 8B illustrate a variation in the cancellation procedure described above. The communication procedure is shown in 8A and the communication contents are shown in 8B. A cancellation request (s51) is sent by the member 100, through a suitable procedure, for a transaction with a specific order number to the shop 110. The shop server 20b sends the cancellation request message to the member maintenance server 20a of the settlement agency specific to the order number (s52). Moreover, the cancellation request report message is sent to the transaction approval server 20c (s53).

The member maintenance server 20a searches to the member information corresponding to the order number in the cancellation request message, and determines whether the applicable transaction may be canceled based on whether the substitute billing was already taken place. The member maintenance server sends the result of such determination to transaction approval server as a cancellation completion result message (s54).

The transaction approval server 20c compares the order number in the cancellation completion result message with order number in the cancellation request report message sent by the shop server 20b. If the numbers match, the certificate (cancellation certificate) for cancellation procedure for the specific transaction is created, and a cancellation verification message that includes such certificate and the order number is sent to the member maintenance server 20a (s55). Also, in this example, at a suitable point in the cancellation procedure, such as the creation for the cancellation certificate and the dispatched time of the cancellation request message, is defined as the cancellation time, and such time is included in the cancellation verification message.

The member maintenance server 20a stores selected information from the cancellation verification message received from the transaction approval server 20c with applicable member information. The member maintenance server sends a cancellation completion result report message which includes the result of the determination to the shop server 20b (s56).

Settlement

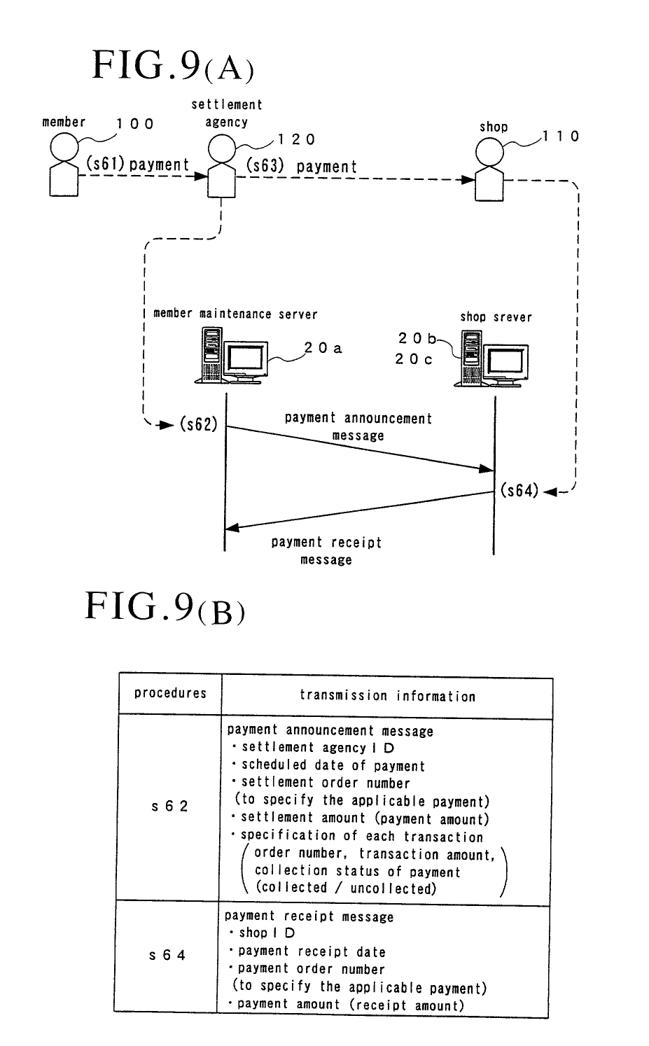

This procedure involves depositing the transaction payment that was collected from the member by the settlement agent with the shop. FIGS. 9A and 9B show the procedures relating to such procedure and the information exchanged, respectively. The settlement agency 120 collects the payment relating to the electronic commerce transaction from the member 100 in a fixed period (s61). The member maintenance server 20a, based on the member information relating to the member 100, calculates all transaction payments relating to electronic commerce transactions with specific shop 110 accrued within the payment calculation period out of all payments collected from such member 100. Then, the payment announcement message that includes scheduled date of payment, amount payable in such scheduled date, settlement order number to specify the applicable payment itself, and specification of entire transaction is sent to the shop server 20b (s62). Also, the specification includes the order number, payment amount, and the collection status of such payment (collected/uncollected) concerning each transaction accrued in the payment calculation period.

When the settlement agency 120 pays (s63) the settlement payment, which were collected by billing substitute, to shop 110 by various ways, such as depositing the payment in the specified account, the shop server 20b sends the payment receipt message, against the payment specific to the payment order number, that states the payment receipt date and the payment amount to the member maintenance server 20a (s64).

Also, in addition to the procedure described above, the member maintenance server 20a prepares a substitute-billing list assigned to the execution situation for remittance or a substitute-billing amount in the order number for each shop that had transaction. The member maintenance servers then sends the applicable substitute-billing list to those computer that requests to access such list when it was sent to the shop.

Settlement Agency Information—Shop Information Renewal

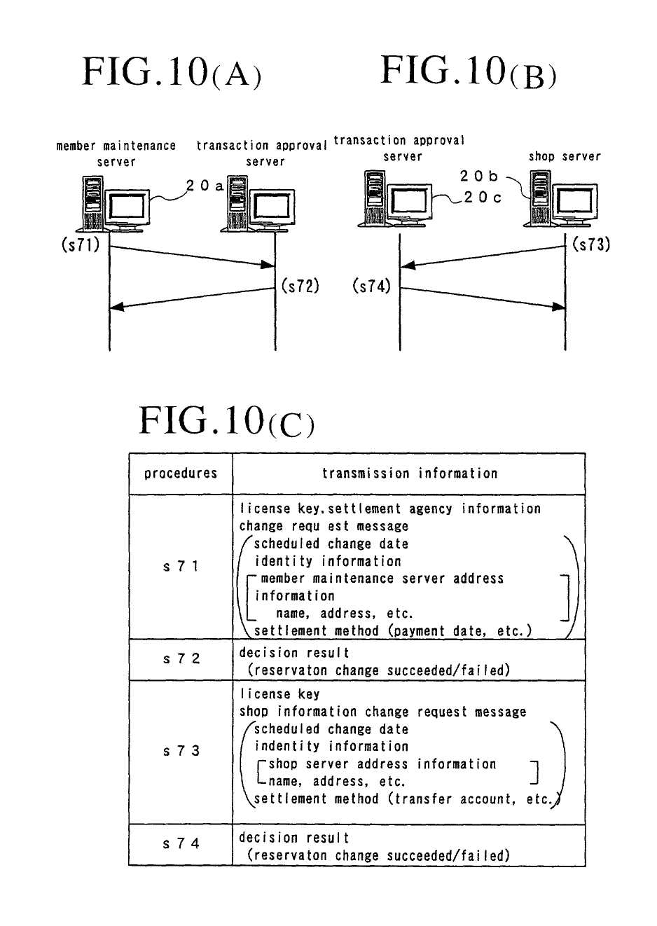

The settlement agency information and the shop information need to be renewed or updated according to changes in the identity information, such as the address and the address of the server, or in the settlement method, such as remittance financial institution. FIG. 10A shows the communication procedure for the transaction approval server 20c and the member maintenance server 20a when the renewal procedure is made on-line. FIG. 10B shows the communication procedure for the transaction approval server 20c and the shop server 20b. FIG. 10C shows the contents of information in these communication procedures.

In this example, the member maintenance server 20a or the shop server 20b sends the renewed information and the scheduled date of the renewal to the transaction approval server 20c (s71,s73). The transaction approval server responds if it is possible to complete the renewal on such scheduled date, and renews the information sent in the specified information on scheduled date (s72,s74). If the renewal is impossible on the scheduled date, the transaction approval server responds accordingly. The shop or the settlement agency may copy against the response for the impossibility by making the suitable change of the scheduled change date.

Transaction Stoppage

In the method according to the present invention, the shop server 20b may decides whether to send the substitute-billing request to the member maintenance server 20a after confirming the contents of the settlement agency identification guarantee message. For example, the database for the conditions (deposition date) for the settlement method or the names of the settlement agency that do not make transaction is prepared, and compared with the settlement agency identification guarantee information that were sent. If the conditions were not met, then the transaction is stopped by notifying the member computers that it will not make the substitute-billing request.

Similarly, the member maintenance server may decide whether to proceed with the substitute billing after confirming the shop information relating to the shop server that sent the substitute-billing request in the shop identification guarantee message. Then it notifies the shop server if it rejects the substitute billing.

Identity Information Maintenance

The member maintenance server 20a or the shop server 20b should store the identity information of communication partner in a certain electronic commerce event. By doing so, it is not necessary to make identity confirmation of the other party to the transaction approval server 20c when it deals with the same party. In this case, it is better to set up the valid terms for the stored identity information, in case that the various identity information, such as IP address of the communication partner, is changed. If the valid term of identity information of the other party has expired when the electronic commerce transaction is made with the same partner, then it can request the transaction approval server for the identity information again. In the alternative, it can regularly request the identity information of such partner once it made the transaction.

Address Information Confirmation

The present invention also provides the address information of the member computer that accessed the member maintenance server or the shop server to better ensure the guarantee of identity of the computer that made access to the member maintenance server 20a or the shop server 20b.

If the substitute-billing request procedure is used as an example, the member maintenance server 20a investigates the identity of shop by sending to the transaction approval server 20c the shop ID attached in the substitute-billing request message sent by the member computer that accessed the shop server. The existence of the shop to which the license key was issued can be verified if the shop information relating to the shop ID exists. However, the identity of the computer itself that sent the shop ID is not guaranteed. Therefore, the member maintenance server 20a receives the ID address of the computer that accessed the shop server, and sends the shop identity search request message that includes shop ID to the transaction approval server 20c.

The transaction approval server 20c returns the shop identification guarantee message that includes the address information (IP address of the shop server 20b) indicated in the shop information relating to the shop ID to the member maintenance server 20a, and the member maintenance server 20a compares the IP address in this message with the IP address previously received, and the subsequent procedures in the electronic commerce transaction are continued if these two match.

The member maintenance server 20a may guarantee the identity of the shop, if the IP address of the shop server received by the substitute-billing request message is included in the shop identification search request message, and the shop information relating to both the IP address and the shop ID within such message in the transaction approval server 20c exists. Similarly, the identity of the settlement agency is more definitely guaranteed if the settlement agency ID in the transaction completion report message is made as a essential information, and the shop server 20b receives the IP address of the computer that sent the transaction completion report message, and compares the IP address of the member maintenance server 20a that sent the substitute-billing request message previously with such IP address.

Of course, the verification by way of IP address can also be applied to the various procedures accrued in other electronic commerce transactions, such as settlement procedure or the cancellation procedure. For example, if the member maintenance server 20a, in the settlement procedure in the form of inspecting the substitute-billing list, accepts or rejects the inspection by comparing the address information assigned to the shop ID sent by a computer and the address information of the computer that requested the inspection, then the list does not pass to the third party.

Furthermore, the appropriate time to inquire as to the address information of the other party in the transaction to the transaction approval server 20c may be if the valid terms of identity information of the other party has expired when the member maintenance server 20a and the shop server 20b are actually communicating, or the address information of the other party in actual communication is different from the address information already stored due to the change in the identity information.

Alternative IP Connection

In the example 1 above, the member computer connects to the Internet via dial-up. However, the present invention also is suitable for other forms of Internet connection, such as the private line connection wherein the member computer is assigned to a fixed IP address.

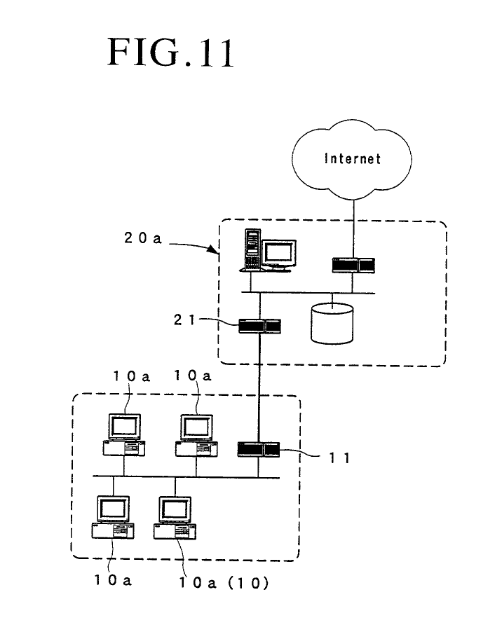

FIG. 11 illustrates the network structure when the provider is designated as the settlement agent and which the member computer is assigned the fixed IP address and is referred to as example 2. Numerous user computers 10a and the router 11 are connected to the LAN. Each user computer 10a is assigned with a fixed IP address. Router 11 and the provider router 21 are connected by a private line. In this form of connection, the member can use any of the user computers.

The web page (log-in screen) with blank space (form) for verification information of log in procedure is prepared in the member maintenance server 20a. The member uses a certain computer 10 and the browser retrieves this log in screen. The verification information such as member ID and the password and entered in the designated blank space in this computer 10, and returned to the member maintenance server.

After the member maintenance server 20a compares the applicable member information with the verification information returned, the user of this computer 10 is verified as the member and receives the IP address of this computer 10a. This computer 10 is logged in to the member maintenance server 20a as the member maintenance server 20a. The log in periods and the ID address of the member computer is recorded with the applicable member information. Therefore, the member maintenance server 20a provides identity guarantee of the member computer 10 (user) during the log in periods.

In this model, the only difference is that the member maintenance server 20a monitors and records the log in periods after receiving the IP address of computer 10 that made the log in. The other procedures (cancellation etc.) and procedures relating to the electronic commerce are same as in example 1.

If the member computer 10 is to log off from the member maintenance server 20a, then the web page for the log off is prepared in the member maintenance server 20a, and the member computer 10 can receive such page and merely follow the specific instructions or it is possible to automatically log off after passing the designated time since log in.

A preferred method is to use the JAVA Apurret. For example, the member maintenance server 20a sends JAVA Apurret to the member computer 10 that made the log in to constantly display the browser screen (subordinate screen) different from the browser screen displayed in the web page for the log in. The preset button to the CGI link for the log off completion is set up in this subordinate screen, and if this button is click by the mouse in this member computer 10, then it logs off.

Alternative Settlement Agency

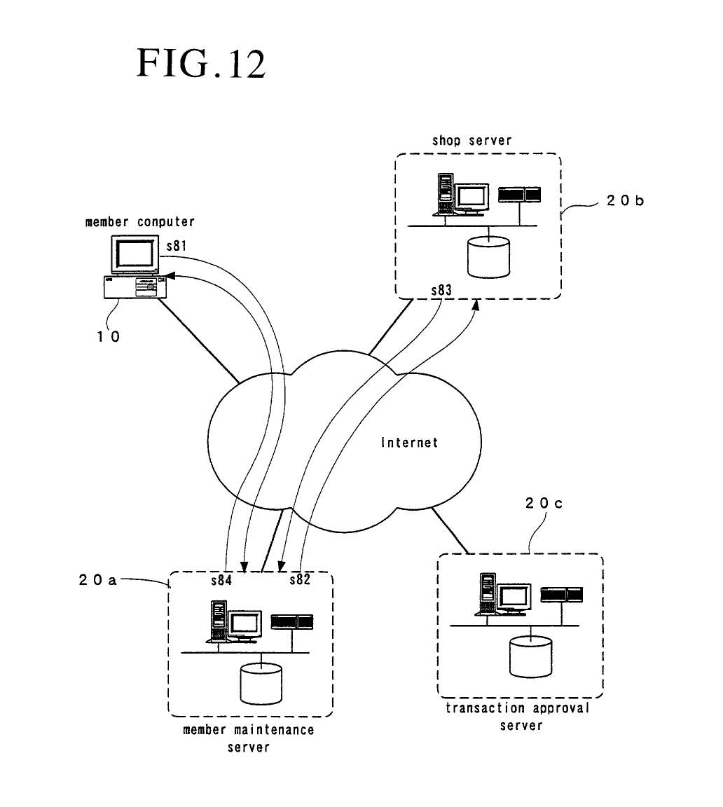

This embodiment provides for an agency other than the provider to be the settlement agency. This embodiment is shown in FIG. 12 and referred to as Example 3.

For example, if a bank is designated as the settlement agency, and if such bank is to maintain the customer with deposit account as the member in the member maintenance server 20a, then this member maintenance server 20a functions as the proxy (representative) server. The member contracts with a free provider and makes the suitable forms of Internet connection, such as dial-up or the private line. The member, by setting the proxy set up of the browser installed in the member computer 10 to the proxy server 20a (member maintenance server) operated by the settlement agency, can have the web page sent to the browser through member maintenance server 20a.

Similar to the log in procedure in example 2 above, the member computer 10 receives log in screen from the member maintenance server 20a and logs in by returning the verification information that was entered into such screen. The member maintenance server 20a provides the identity guarantee of the member computer during the member computer's log in and log out period.

If the logged in member computer 10 transmits the HTTP request, addressed to the shop server 20b, on the Internet, then, this request is sent to the member maintenance server 20a according to the proxy set up (s81). The member maintenance server 20a converts the IT address of such request sender into the IP address of itself. Then, the request is sent to the shop server 20b by resending the converted IP address as the IP address of the sender from the HTTP request to the Internet (s82). When the shop server 20b receives the request, it returns the HTTP response to the member maintenance server 20a (s83), and the member maintenance server 20a converts the return IP address of the HTTP response into the IP address of the member computer 10, and by resending such HTTP response to the Internet, the concerned response is sent to the member computer 10 (s84).

As the member maintenance server 20a maintains when and which IP address is assigned to the logged in member computer 10 by relating them to the applicable member information, it is possible to apply method of credit guarantee in the present invention when the member computer 10 and the shop server 20b are involved in an electronic commerce transaction.

Moreover, it is often that the proxy set up of the web browser of the computers installed in a school or business cannot be changed at free will. To apply the method of the present invention in electronic commerce transactions under such computer installation environment, the member maintenance server 20a may employ the method of receiving the exclusive browser, prepared as the JAVA Apurret, for electronic commerce transactions.

Such exclusive browser already has the proxy set up to view the web page through member maintenance server 20b. If the log in screen is automatically displayed before such browser views the web, then it is possible to prevent the use of such exclusive browser unless it logs in. Then, the settlement agency makes the identity guarantee of the user of member computer, as member, that uses the exclusive browser.

Other Applications

Redirection

When and if the member maintenance server 20a wants to send the transaction confirmation notice to the applicable member computer 10, it is possible to use the “redirection function” of HTTP rather than relying on the “plug in.” The shop server 20b reacts to the product purchase event sent as the HTTP, and sends the HTTP redirection respond, which includes the URL to receive the transaction confirmation notice from the member maintenance server 20a, to the member computer 10. As result, the member maintenance server 20a sends the web page, equivalent to the transaction confirmation notice prepared according to the procedures s24 through s28 in FIG. 5, to the member computer 10a. In this case, the member maintenance server 10a registers, to the transaction approval server 20b, the URL to receive the transaction confirmation notice, as one of the address information relating to the settlement agency information, and the transaction approval server 20c can easily include such URL in the settlement agency identification guarantee message.

Moreover, in the transaction completion notice, the member maintenance server 20a reacts to the completion notice by the member computer and send the HTTP redirect response, which includes the URL to receive the transaction completion notice from the shop server 20b, to the member computer 10.

Anonymous User ID

As mentioned above, the anonymous user ID, used to specify the member who made the electronic commerce without disclosing the private information, is illustrated by models using the IP address of the computer that generated the product purchase event. However, it is possible to use other information as the anonymous user ID rather than the IP address. For example, cookies can be used. For example, the member computer logs into the member maintenance server through web page in the log in page, the member maintenance server generates the cookie to the member computer. The member maintenance server maintains by assigning the log in period and the cookie of the member computer. The cookie is disclosed to the shop server when the member computer and the shop server pursue the electronic commerce transaction. Of course, the transaction approval server is said to maintain the information as the settlement agency information by assigning the cookie to the specific settlement agency.

The interconnection network, comprised of the numerous LANs, without limiting to the Internet, may use the MAC address as the anonymous user ID. If the transaction approval server maintains the association between the anonymous user ID and the settlement agency, then the data form (IP address, cookie etc.) of the anonymous user ID can differ among the settlement agencies.

Shop Distinction Information, Settlement Agency Distinction Information

In example 1, when the member maintenance server and the shop server communicated, they provided the settlement agency ID and the shop ID as the information relating to the identity of themselves. If the identity information of the settlement agency or the shop is registered in the transaction approval server, then, instead of these IDs, for example, it can be the network name such as the domain name of the settlement agency or the shop itself, or the names of the settlement agency or the shop.

Address Information

In the example 1 above, the shop server reacts to the product purchase event from the member computer, and sends the anonymous user ID to the transaction approval server, and acquires the address information of the member maintenance server, as the settlement identification guarantee message, for the delivery address for the substitute-billing request message. Other than this receipt procedure, the transaction approval server may acquire, in advance, by sending the address information of the member maintenance server, information relating to the anonymous user ID used by the applicable settlement agency, and the address information of the member maintenance server to the shop server. Of course, the data recording media, such as CD-ROM, with information relating to the anonymous user ID and the address information of the member maintenance server may be distributed to the shops in advance, and the shop server could maintain the information in such media by reading the information inside.

History of Transaction

In the example 1 above, the member maintenance server, at the time it receives the transaction completion confirmation from the member, assigns the applicable member information with the information selected from the substitute-billing request message and the order number and maintain this assignment as the last record of a certain transaction. However, although obvious, the history relating to a certain transaction starts from dispatching of the substitute-billing request message. Then, the information created or receives in the communication events occurred thereafter shall be added to the applicable history of the transaction at any time. Also, until the order number is created, the pair of anonymous user ID and the transaction date may be used as the suitable information to specify a transaction. Moreover, the shop may issue and use the transaction number as the temporary distinction information until the transaction is completed.

Of course, the transaction record book of the transaction approval server or the sales record book of the shop server shows the recording status among selected information at the end of completion of the transaction.

Order Number

In the example 1 above, the member maintenance server creates the order number when it receives the shop identification guarantee message from the transaction approval server. However, the order number may be created at suitable time after the substitute-billing request message is sent from the shop server. Moreover, the place to create the order number does not have to be limited to the member maintenance server, but it is also the shop server. For example, the shop server creates the order number by reacting to the product purchase event, and follow the procedure of completing the applicable transaction by circulating such order number among each server.

The method of the present invention in which the settlement agency to collect the product purchase payment from the member on behalf of the product selling entity when there is an electronic commerce transaction through an interconnection network, such as Internet, between the member registered in a certain settlement agency and the product selling entity, and that the credit guarantee entity provides for evidence preservation of the commercial transaction and the identification guarantee of both the product selling entity and the settlement agency, and allows the settlement agency provide the identity guarantee of the member. Therefore, it is possible to secure high degree of the reliability against such an inconsistent task of “credit guarantee by concealing the private information.”

The transaction approval server in the electronic commerce can guarantee the identity of the other party against the request from the product selling entity and the settlement agency, and verify the specific order number unique to a transaction by forcing both entities to send such number. Thereby, the forged transaction or fabrication of content of the transaction can be avoided and eliminated.

By maintaining the transaction in the order number, it can specify the applicable transaction by the order number after the cancellation, and the transaction approval server can compare the order number, subject to the cancellation, received from both the member maintenance server and the shop server, and make the guarantee in high degree of reliability in cancellation procedure.

For electronic commerce transactions pursuant to the method of present invention, the serial number is assigned to the programs that are installed in the host computer, and the serial number is sent to the transaction approval server when installed, and the identity information of the installation base is registered. The license key is issued in exchange for such serial number and the registration of the identity information to make possible access to the transaction approval server. Thereby, it is possible to eliminate the appearance of forgers who make fraudulent copies of program itself.

By prohibiting the access by the computer without the license key, the transaction approval server can respond to instances where the legitimate product selling entity or the settlement agency changes the identity information and others on line. Therefore, unless it is changed in very important items, it is not necessary to make changes in writing and therefore, it eliminates or shortens the period of stoppage in the electronic commerce transactions due to procedures.

The member maintenance server or the shop server may eliminate the forged message by verifying the address information of the other party included in the message sent by the transaction approval server with the address information of the actual party in communication.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A method for guaranteeing credit in electronic commerce transactions between at least one member and at least one retail entity, the method comprising:
accessing a member maintenance server operated by a settlement agency by a member desiring an electronic commerce transaction with a retail entity, wherein the member maintenance server verifies the member's identification and any associated member information of the member;
generating selected information relating to at least one of selected payment method information and associated private information about the retail entity from selected information obtained from a transaction approval server operated by a credit guarantee institution and transmitting the selected information to at least one of the member maintenance server and retail entity server which requested the information;
generating an anonymous user identification from selected information obtained from at least one of the member which accessed the retail server and the member maintenance server and transmitting the anonymous user identification from the member maintenance server to the retail entity server;
generating a settlement agency identification search request message from selected information obtained from the retail entity server and transmitting the settlement agency identification search request message from the retail entity server to the transaction approval server, wherein the settlement agency identification search request message includes the anonymous user identification for the member;
searching settlement agency information for information related to the anonymous user identification obtained from the retail entity server and transmitting selected information related to the anonymous user identification from the transaction approval server to the retail entity server;
generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
generating a retail entity identification guarantee message from selected information obtained from the transaction approval server and transmitting the retail entity identification guarantee message containing the selected information from the transaction approval server to the member maintenance server;
verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;
verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, storing the order number and selected information from at least one of the settlement agency identification guarantee message and the billing agency identification request message in a sales record database within the retail entity server.

2. The method according to claim 1 wherein the method further comprises:
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server; and
upon receipt of the cancel process result message by the transaction verification server, storing selected information from the cancel process result message in a transaction record database within the transaction verification server.

3. The method according to claim 1 wherein the method further comprises
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server;
upon receipt of the cancel process result message by the transaction verification server, verifying that the order number sent with the cancel request notice corresponds to the order number sent with the cancel process result message;
upon verification, generating a cancel verification message from selected information obtained from the transaction verification server and transmitting the cancel verification message from the transaction verification server to the member maintenance server; and
compiling selected information from the cancel process result message and the cancel verification message obtained by the member maintenance server and transmitting the selected information to the retail entity server.

4. The method according to claim 1 wherein the method further comprises:
installing a specified retail entity program on the retail entity server;
upon installation, generating a retail entity registration request message from selected information obtained during the installation of the program and transmitting the retail entity registration request message from the retail entity server to the transaction approval server, wherein the retail entity registration request message includes the serial number of the program and any associated information obtained during the installation;
verifying the serial number contained in the retail entity registration request message to determine whether such serial has been previously registered, and upon verification that the serial number has not been previously registered, generating a unique retail entity license key for the retail entity program installed on the retail entity server and transmitting the license key and any associated information from the transaction approval server to the retail entity server;
transmitting the license key and any associated information to a database within the transaction approval server, and maintaining and periodically updating information relating to the license key in the database; and
when accessing to the transaction approval server, transmitting the license key associated with the retail entity server to the transaction approval server.

5. The method according to claim 1 wherein the method further comprises:
installing a specified settlement agency program on a settlement agency computer;
upon installation, generating a settlement agency registration request message from selected information obtained during the installation of the program and transmitting the settlement agency registration request message from the settlement agency computer to the transaction approval server, wherein the settlement agency registration request message includes the serial number of the program and any associated information obtained during the installation;
verifying the serial number contained in the settlement agency registration request message to determine whether such serial has been previously registered, and upon verification that the serial number has not been previously registered, generating a unique settlement agency license key for the settlement agency program installed on the settlement agency computer, and transmitting the license key and any associated information from the transaction approval server to the settlement agency computer;
transmitting the license key and any associated information to a database within the transaction approval server, and maintaining and periodically updating information relating to the license key in the database; and
when accessing to the transaction approval server, transmitting the license key associated with the settlement agency computer to the transaction approval server.

6. The method according to claim 1 wherein the method further comprises:
generating a retail entity information change request message from selected information obtained from the retail entity server in response to a change in retail entity information and transmitting the retail entity information change request message from the retail entity server to the transaction approval server; and
in response to the retail entity information change request message, modifying selected information related to the retail entity stored within the transaction approval server according to the retail entity information change request message.

7. The method according to claim 1 wherein the method further comprises:
generating a settlement agency information change request message from selected information obtained from the member maintenance server in response to a change in settlement agency information and transmitting the settlement agency information change request message from the member maintenance server to the transaction approval server; and
in response to the settlement agency information change request message, modifying selected information related to the settlement agency stored within the transaction approval server according to the settlement agency information change request message.

8. The method according to claim 1 wherein the method further comprises:
compiling selected retail entity identification information for a retail entity server received from a computer which accessed the member maintenance server and obtaining the address of the computer which accessed the member maintenance server;
transmitting the retail entity identification information from the member maintenance server to the transaction approval server as needed by the transaction approval server;
generating a related retail entity information message from selected information obtained from the transaction approval server and transmitting the related retail entity information message from the transaction approval server to the member maintenance server, wherein the related retail entity information includes selected information from the retail entity identification information and the address of the retail entity server;
correlating the address information for the retail entity server received from the transaction approval server with the address information received from the computer which accessed the member maintenance server to determine if the address information is the same; and
if the address information received by the transaction approval server and the computer which accessed the member maintenance server are the same, acknowledging the computer which accessed the member maintenance server as the retail entity server.

9. The method according to claim 1 wherein the method further comprises:
compiling selected settlement agency identification information for a member maintenance server received from a computer which accessed the retail entity server and obtaining the address of the computer which accessed the retail entity server;
transmitting the settlement agency identification information from the retail entity server to the transaction approval server as needed by the transaction approval server;
generating a related settlement agency information message from selected information obtained from the transaction approval server and transmitting the related settlement agency information message from the transaction approval server to the retail entity server, wherein the related settlement agency information includes selected information from the settlement agency identification information and the address of the member maintenance server;
correlating the address information for the member maintenance server received from the transaction approval server with the address information received from the computer which accessed the retail entity server to determine if the address information is the same; and
if the address information received by the transaction approval server and the computer which accessed the retail entity server are the same, acknowledging the computer which accessed the retail entity server as the member maintenance server.

10. A method for guaranteeing credit in electronic commerce transactions between at least one member and at least one retail entity, the method comprising:
accessing a member maintenance server operated by a settlement agency by a member desiring an electronic commerce transaction with a retail entity, wherein the member maintenance server verifies the member's identification and any associated member information of the member;
generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;
generating a settlement agency identification guarantee message from selected information obtained from the transaction approval server and transmitting the settlement agency identification guarantee message from the transaction approval server to the retail entity server;
generating an anonymous user identification from selected information obtained from the member which accessed the retail server and transmitting the anonymous user identification from the member to the retail entity server;
compiling selected address information relating to the member maintenance server assigned to the anonymous user identification from selected information contained in the settlement agency identification guarantee message received by the retail entity server;
generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
generating a retail entity identification guarantee message from selected information obtained from the transaction approval server and transmitting the retail entity identification guarantee message containing the selected information from the transaction approval server to the member maintenance server;
verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;
verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, storing the order number and selected information from at least one of the settlement agency identification guarantee message and the billing agency identification request message in a sales record database within the retail entity server.

11. The method according to claim 10 wherein the method further comprises:
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server; and
upon receipt of the cancel process result message by the transaction verification server, storing selected information from the cancel process result message in a transaction record database within the transaction verification server.

12. The method according to claim 10 wherein the method further comprises
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server;
upon receipt of the cancel process result message by the transaction verification server, verifying that the order number sent with the cancel request notice corresponds to the order number sent with the cancel process result message;
upon verification, generating a cancel verification message from selected information obtained from the transaction verification server and transmitting the cancel verification message from the transaction verification server to the member maintenance server; and
compiling selected information from the cancel process result message and the cancel verification message obtained by the member maintenance server and transmitting the selected information to the retail entity server.

13. The method according to claim 10 wherein the method further comprises:
installing a specified retail entity program on the retail entity server;
upon installation, generating a retail entity registration request message from selected information obtained during the installation of the program and transmitting the retail entity registration request message from the retail entity server to the transaction approval server, wherein the retail entity registration request message includes the serial number of the program and any associated information obtained during the installation;
verifying the serial number contained in the retail entity registration request message to determine whether such serial has been previously registered, and upon verification that the serial number has not been previously registered, generating a unique retail entity license key for the retail entity program installed on the retail entity server and transmitting the license key and any associated information from the transaction approval server to the retail entity server;
transmitting the license key and any associated information to a database within the transaction approval server, and maintaining and periodically updating information relating to the license key in the database; and
when accessing to the transaction approval server, transmitting the license key associated with the retail entity server to the transaction approval server.

14. The method according to claim 10 wherein the method further comprises:
installing a specified settlement agency program on a settlement agency computer;
upon installation, generating a settlement agency registration request message from selected information obtained during the installation of the program and transmitting the settlement agency registration request message from the settlement agency computer to the transaction approval server, wherein the settlement agency registration request message includes the serial number of the program and any associated information obtained during the installation;
verifying the serial number contained in the settlement agency registration request message to determine whether such serial has been previously registered, and upon verification that the serial number has not been previously registered, generating a unique settlement agency license key for the settlement agency program installed on the settlement agency computer, and transmitting the license key and any associated information from the transaction approval server to the settlement agency computer;
transmitting the license key and any associated information to a database within the transaction approval server, and maintaining and periodically updating information relating to the license key in the database; and
when accessing to the transaction approval server, transmitting the license key associated with the settlement agency computer to the transaction approval server.

15. The method according to claim 10 wherein the method further comprises:
generating a retail entity information change request message from selected information obtained from the retail entity server in response to a change in retail entity information and transmitting the retail entity information change request message from the retail entity server to the transaction approval server; and
in response to the retail entity information change request message, modifying selected information related to the retail entity stored within the transaction approval server according to the retail entity information change request message.

16. The method according to claim 10 wherein the method further comprises:
generating a settlement agency information change request message from selected information obtained from the member maintenance server in response to a change in settlement agency information and transmitting the settlement agency information change request message from the member maintenance server to the transaction approval server; and
in response to the settlement agency information change request message, modifying selected information related to the settlement agency stored within the transaction approval server according to the settlement agency information change request message.

17. The method according to claim 10 wherein the method further comprises:
compiling selected retail entity identification information for a retail entity server received from a computer which accessed the member maintenance server and obtaining the address of the computer which accessed the member maintenance server;
transmitting the retail entity identification information from the member maintenance server to the transaction approval server as needed by the transaction approval server;
generating a related retail entity information message from selected information obtained from the transaction approval server and transmitting the related retail entity information message from the transaction approval server to the member maintenance server, wherein the related retail entity information includes selected information from the retail entity identification information and the address of the retail entity server;
correlating the address information for the retail entity server received from the transaction approval server with the address information received from the computer which accessed the member maintenance server to determine if the address information is the same; and
if the address information received by the transaction approval server and the computer which accessed the member maintenance server are the same, acknowledging the computer which accessed the member maintenance server as the retail entity server.

18. The method according to claim 10 wherein the method further comprises:
compiling selected settlement agency identification information for a member maintenance server received from a computer which accessed the retail entity server and obtaining the address of the computer which accessed the retail entity server;
transmitting the settlement agency identification information from the retail entity server to the transaction approval server as needed by the transaction approval server;
generating a related settlement agency information message from selected information obtained from the transaction approval server and transmitting the related settlement agency information message from the transaction approval server to the retail entity server, wherein the related settlement agency information includes selected information from the settlement agency identification information and the address of the member maintenance server;
correlating the address information for the member maintenance server received from the transaction approval server with the address information received from the computer which accessed the retail entity server to determine if the address information is the same; and
if the address information received by the transaction approval server and the computer which accessed the retail entity server are the same, acknowledging the computer which accessed the retail entity server as the member maintenance server.

19. A method for guaranteeing credit in electronic commerce transactions between at least one member and at least one retail entity, the method comprising:
accessing a member maintenance server operated by a settlement agency by a member desiring an electronic commerce transaction with a retail entity, wherein the member maintenance server verifies the member's identification and any associated member information of the member;
generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;
periodically accessing and obtaining selected information from the member maintenance server and maintain such information in a settlement agency identification guarantee information database on the retail entity server;
generating an anonymous user identification from selected information obtained from the member which accessed the retail server and transmitting the anonymous user identification from the member to the retail entity server;
compiling selected address information relating to the member maintenance server assigned to the anonymous user identification from selected information contained in the settlement agency identification guarantee information database on the retail entity server;
generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
generating a retail entity identification guarantee message from selected information obtained from the transaction approval server and transmitting the retail entity identification guarantee message containing the selected information from the transaction approval server to the member maintenance server;
verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, generating a transaction verification request message from selected information obtained from the retail entity server, and transmitting the transaction verification request message from the retail entity server to the transaction approval server, wherein the transaction verification request message includes the order number;
verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, storing the order number and selected information from at least one of the settlement agency identification guarantee message and the billing agency identification request message in a sales record database within the retail entity server.

20. The method according to claim 19 wherein the method further comprises:
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server; and
upon receipt of the cancel process result message by the transaction verification server, storing selected information from the cancel process result message in a transaction record database within the transaction verification server.

21. The method according to claim 19 wherein the method further comprises
generating a cancel request notice message in response to a cancellation request received from a selected one of the member and the retail entity, transmitting the cancel request notice message and the order number from the retail entity server to the transaction verification server, and transmitting the cancel request notice and selected retail entity identification information from the retail entity server to the member maintenance server;
determining, based on the information received in the cancel request notice message from the retail entity server by the member maintenance server, whether to stop any billing process related to the transaction and storing selective information relating to such determination with the associated member information;
generating a cancel process result message from selective information relating to such determination, transmitting the cancel process result message from the member maintenance server to the retail entity server, and transmitting the cancel process notice message and the order number from the member maintenance server to the transaction verification server;
upon receipt of the cancel process result message by the transaction verification server, verifying that the order number sent with the cancel request notice corresponds to the order number sent with the cancel process result message;
upon verification, generating a cancel verification message from selected information obtained from the transaction verification server and transmitting the cancel verification message from the transaction verification server to the member maintenance server; and
compiling selected information from the cancel process result message and the cancel verification message obtained by the member maintenance server and transmitting the selected information to the retail entity server.

22. The method according to claim 19 wherein the method further comprises:
installing a specified retail entity program on the retail entity server;
upon installation, generating a retail entity registration request message from selected information obtained during the installation of the program and transmitting the retail entity registration request message from the retail entity server to the transaction approval server, wherein the retail entity registration request message includes the serial number of the program and any associated information obtained during the installation;
verifying the serial number contained in the retail entity registration request message to determine whether such serial has been previously registered, and upon verification that the serial number has not been previously registered, generating a unique retail entity license key for the retail entity program installed on the retail entity server and transmitting the license key and any associated information from the transaction approval server to the retail entity server;
transmitting the license key and any associated information to a database within the transaction approval server, and maintaining and periodically updating information relating to the license key in the database; and
when accessing to the transaction approval server, transmitting the license key associated with the retail entity server to the transaction approval server.

23. The method according to claim 19 wherein the method further comprises:
installing a specified settlement agency program on a settlement agency computer;
upon installation, generating a settlement agency registration request message from selected information obtained during the installation of the program and transmitting the settlement agency registration request message from the settlement agency computer to the transaction approval server, wherein the settlement agency registration request message includes the serial number of the program and any associated information obtained during the installation;
verifying the serial number contained in the settlement agency registration request message to determine whether such serial has been previously registered, and upon verification that the serial number has not been previously registered, generating a unique settlement agency license key for the settlement agency program installed on the settlement agency computer, and transmitting the license key and any associated information from the transaction approval server to the settlement agency computer;
transmitting the license key and any associated information to a database within the transaction approval server, and maintaining and periodically updating information relating to the license key in the database; and
when accessing to the transaction approval server, transmitting the license key associated with the settlement agency computer to the transaction approval server.

24. The method according to claim 19 wherein the method further comprises:
generating a retail entity information change request message from selected information obtained from the retail entity server in response to a change in retail entity information and transmitting the retail entity information change request message from the retail entity server to the transaction approval server; and
in response to the retail entity information change request message, modifying selected information related to the retail entity stored within the transaction approval server according to the retail entity information change request message.

25. The method according to claim 19 wherein the method further comprises:
generating a settlement agency information change request message from selected information obtained from the member maintenance server in response to a change in settlement agency information and transmitting the settlement agency information change request message from the member maintenance server to the transaction approval server; and
in response to the settlement agency information change request message, modifying selected information related to the settlement agency stored within the transaction approval server according to the settlement agency information change request message.

26. The method according to claim 19 wherein the method further comprises:
compiling selected retail entity identification information for a retail entity server received from a computer which accessed the member maintenance server and obtaining the address of the computer which accessed the member maintenance server;
transmitting the retail entity identification information from the member maintenance server to the transaction approval server as needed by the transaction approval server;
generating a related retail entity information message from selected information obtained from the transaction approval server and transmitting the related retail entity information message from the transaction approval server to the member maintenance server, wherein the related retail entity information includes selected information from the retail entity identification information and the address of the retail entity server;
correlating the address information for the retail entity server received from the transaction approval server with the address information received from the computer which accessed the member maintenance server to determine if the address information is the same; and
if the address information received by the transaction approval server and the computer which accessed the member maintenance server are the same, acknowledging the computer which accessed the member maintenance server as the retail entity server.

27. The method according to claim 19 wherein the method further comprises:
compiling selected settlement agency identification information for a member maintenance server received from a computer which accessed the retail entity server and obtaining the address of the computer which accessed the retail entity server;
transmitting the settlement agency identification information from the retail entity server to the transaction approval server as needed by the transaction approval server;
generating a related settlement agency information message from selected information obtained from the transaction approval server and transmitting the related settlement agency information message from the transaction approval server to the retail entity server, wherein the related settlement agency information includes selected information from the settlement agency identification information and the address of the member maintenance server;
correlating the address information for the member maintenance server received from the transaction approval server with the address information received from the computer which accessed the retail entity server to determine if the address information is the same; and
if the address information received by the transaction approval server and the computer which accessed the retail entity server are the same, acknowledging the computer which accessed the retail entity server as the member maintenance server.

28. A system for guaranteeing credit in electronic commerce transactions between at least one member and at least one retail entity, the system comprising:
means adapted for accessing a member maintenance server operated by a settlement agency by a member desiring an electronic commerce transaction with a retail entity, wherein the member maintenance server verifies the member's identification and any associated member information of the member;
means adapted for generating selected information relating to at least one of selected payment method information and associated private information about the retail entity from selected information obtained from a transaction approval server operated by a credit guarantee institution and transmitting the selected information to at least one of the member maintenance server and retail entity server which requested the information;
means adapted for generating an anonymous user identification from selected information obtained from at least one of the member which accessed the retail server and the member maintenance server and transmitting the anonymous user identification from the member maintenance server to the retail entity server;
means adapted for generating a settlement agency identification search request message from selected information obtained from the retail entity server and transmitting the settlement agency identification search request message from the retail entity server to the transaction approval server, wherein the settlement agency identification search request message includes the anonymous user identification for the member;
means adapted for searching settlement agency information for information related to the anonymous user identification obtained from the retail entity server and transmitting selected information related to the anonymous user identification from the transaction approval server to the retail entity server;
means adapted for generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
means adapted for generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
means adapted for generating a retail entity identification guarantee message from selected information obtained from the transaction approval server and transmitting the retail entity identification guarantee message containing the selected information from the transaction approval server to the member maintenance server;
means adapted for verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
means adapted for storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
means adapted for generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, means adapted for generating a transaction verification request message from selected information obtained from the retail entity server, and transmitting the transaction verification request message from the retail entity server to the transaction approval server, wherein the transaction verification request message includes the order number;
means adapted for verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, means adapted for storing the order number and selected information from at least one of the settlement agency identification guarantee message and the billing agency identification request message in a sales record database within the retail entity server.

29. A system for guaranteeing credit in electronic commerce transactions between at least one member and at least one retail entity, the method comprising:
means adapted for accessing a member maintenance server operated by a settlement agency by a member desiring an electronic commerce transaction with a retail entity, wherein the member maintenance server verifies the member's identification and any associated member information of the member;
means adapted for generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;
means adapted for generating a settlement agency identification guarantee message from selected information obtained from the transaction approval server and transmitting the settlement agency identification guarantee message from the transaction approval server to the retail entity server;
means adapted for generating an anonymous user identification from selected information obtained from the member which accessed the retail server and transmitting the anonymous user identification from the member to the retail entity server;
means adapted for compiling selected address information relating to the member maintenance server assigned to the anonymous user identification from selected information contained in the settlement agency identification guarantee message received by the retail entity server;
means adapted for generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
means adapted for generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
means adapted for generating a retail entity identification guarantee message from selected information obtained from the transaction approval server and transmitting the retail entity identification guarantee message containing the selected information from the transaction approval server to the member maintenance server;
means adapted for verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
means adapted for storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
means adapted for generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, means adapted for generating a transaction verification request message from selected information obtained from the retail entity server, and transmitting the transaction verification request message from the retail entity server to the transaction approval server, wherein the transaction verification request message includes the order number;
means adapted for verifying the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, means adapted for storing the order number and selected information from at least one of the settlement agency identification guarantee message and the billing agency identification request message in a sales record database within the retail entity server.

30. A system for guaranteeing credit in electronic commerce transactions between at least one member and at least one retail entity, the method comprising:
means adapted for accessing a member maintenance server operated by a settlement agency by a member desiring an electronic commerce transaction with a retail entity, wherein the member maintenance server verifies the member's identification and any associated member information of the member;
means adapted for generating selected information relating to at least one of selected payment method information and associated private information about the retail entity from selected information obtained from a transaction approval server operated by a credit guarantee institution and transmitting the selected information from the transaction approval server to at least one of the member maintenance server and retail entity server which requested the information;
means adapted for periodically accessing and obtaining selected information from the member maintenance server and maintain such information in a settlement agency identification guarantee information database on the retail entity server;
means adapted for generating an anonymous user identification from selected information obtained from the member which accessed the retail server and transmitting the anonymous user identification from the member to the retail entity server;
means adapted for compiling selected address information relating to the member maintenance server assigned to the anonymous user identification from selected information contained in the settlement agency identification guarantee information database on the retail entity server;
means adapted for generating a billing agency identification search request message from selected information obtained from the retail entity server and transmitting the billing agency identification search request message from the retail entity server to the member maintenance server, wherein the billing agency identification search request message includes retail entity identification information and the anonymous user identification;
means adapted for generating a retail entity identification search request message from selected information obtained from the member maintenance server and transmitting the retail entity identification search request message from the member maintenance server to the transaction approval server, wherein the retail entity identification search request message includes the retail entity information contained in the billing agency identification search request message;
means adapted for generating a retail entity identification guarantee message from selected information obtained from the transaction approval server and transmitting the retail entity identification guarantee message containing the selected information from the transaction approval server to the member maintenance server;
means adapted for verifying information received from the transaction approval server by the member maintenance server, generating a transaction completion notice from selected information obtained from the member maintenance server, and transmitting the transaction completion notice from the member maintenance server to the member to confirm the associated transaction, wherein the transaction completion notice includes an order number generated by a select one of the member maintenance server and the retail entity server and selected information from at least one of associated member information, retail entity identification guarantee message, and billing agency identification search request message;
means adapted for storing the order number and selected information from the billing agency identification request message at the member maintenance server, generating a transaction completion report message from selected information obtained from the member maintenance server, and transmitting the transaction completion report message from the member maintenance server to the retail entity server; wherein the transaction completion report message includes the order number, selected information from the billing agency identification search request message, and selected information from the transaction completion notice relating to the result of the transaction;
means adapted for generating a transaction report message from selected information obtained from the member maintenance server and transmitting the transaction report message to the transaction confirmation server, wherein the transaction report message includes the order number and selected information from the billing agency identification search request message;
upon receipt of the transaction completion report message by the retail entity server, means adapted for generating a transaction verification request message from selected information obtained from the retail entity server, and transmitting the transaction verification request message from the retail entity server to the transaction approval server, wherein the transaction verification request message includes the order number;
means adapted for verifing the information contained within the transaction report message and transaction verification request message, and upon verification, storing selected information relating to the order number and applicable associated transaction monies in a transaction record database within the transaction approval server, generating a transaction verification message for the order number from selected information obtained from the transaction approval server, and transmitting the transaction verification from the transaction approval server to the retail shop server; and
upon receipt of the transaction verification message by the retail entity server, means adapted for storing the order number and selected information from at least one of the settlement agency identification guarantee message and the billing agency identification request message in a sales record database within the retail entity server.
